(19) United States
(12) Patent Application Publication
(10) Pub. No.: US 2026/0171302 A1
(43) Pub. Date: Jun. 18, 2026

(54) COIL COMPONENT

(71) Applicant: SAMSUNG ELECTRO-MECHANICS CO., LTD., Suwon-si (KR)

(72) Inventors: Dong Hwan LEE, Suwon-si (KR); Dong Jin LEE, Suwon-si (KR); Soon Kwang KWON, Suwon-si (KR); Tae Hyun KIM, Suwon-si (KR); Ju Hyoung PARK, Suwon-si (KR); Dae Ki LIM, Suwon-si (KR)

(73) Assignee: SAMSUNG ELECTRO-MECHANICS CO., LTD., Suwon-si (KR)

(21) Appl. No.: 19/318,791

(22) Filed: Sep. 4, 2025

(30) Foreign Application Priority Data
Dec. 17, 2024 (KR) 10-2024-0188470

(51) Int. Cl. H01F 27/29; H01F 27/28; H01F 27/32

(52) U.S. Cl. CPC H01F 27/292; H01F 27/2852; H01F 27/327

(57) ABSTRACT

A coil component includes a body having a first surface and a second surface, opposing each other in a first direction, a first side surface and a second side surface, opposing each other in a second direction, and a third side surface connecting the first side surface and the second side surface to each other, a coil disposed in the body, the coil including a lead-out portion extending to the third side surface of the body, an external electrode disposed on the third side surface of the body, the external electrode including a connection portion connected to the lead-out portion, and a first insulating layer disposed on the third side surface of the body, the first insulating layer exposing the connection portion.

### CROSS-REFERENCE TO RELATED APPLICATION(S)

This application claims benefit of priority to Korean Patent Application No. 10-2024-0188470 filed on Dec. 17, 2024 in the Korean Intellectual Property Office, the disclosure of which is incorporated herein by reference in its entirety.

### TECHNICAL FIELD

The present disclosure relates to a coil component.

An inductor, a coil component, may be a representative passive electronic component used in electronic devices, along with a resistor and a capacitor.

A power inductor, in addition to inherent inductance properties thereof, may also have a self-resonant frequency (SRF) due to undesired parasitic elements such as capacitance. For power inductors having the same capacitance value, a higher SRF means that an inductor operates at higher frequencies. In a special application field, such as in an ET modulator, it is necessary to freely adjust an SRF of a power inductor to achieve a desired impedance value at a specific frequency.

### SUMMARY

An aspect of the present disclosure is to provide a coil component capable of securing a size of an air core of a coil while reducing parasitic capacitance elements, thereby improving a self-resonant frequency (SRF).

According to an aspect of the present disclosure, there is provided a coil component including a body having a first surface and a second surface, opposing each other in a first direction, a first side surface and a second side surface, opposing each other in a second direction, and a third side surface connecting the first side surface and the second side surface to each other, a coil disposed in the body, the coil including a lead-out portion extending to the third side surface of the body, an external electrode disposed on the third side surface of the body, the external electrode including a connection portion connected to the lead-out portion, and a first insulating layer disposed on the third side surface of the body, the first insulating layer exposing the connection portion. A distance between the connection portion of the external electrode and the first side surface of the body may be different from a distance between the connection portion of the external electrode and the second side surface of the body.

According to the present disclosure, a coil component may secure a size of an air core of a coil while reducing parasitic capacitance elements, thereby improving an SRF.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic view of a coil component according to an example embodiment of the present disclosure;

FIG. 2 is a top view of FIG. 1;

FIG. 3 is a cross-sectional view taken along line I-I′ of FIG. 1;

FIG. 4 is a cross-sectional view taken along line II-II′ of FIG. 1;

FIG. 5 is a view of FIG. 1 in a direction of A;

FIG. 6 is a view of FIG. 1 in a direction of B;

FIG. 7 is a coil component according to a modification, corresponding to FIG. 3;

FIG. 8 is a coil component according to another modification, corresponding to FIG. 5; and

FIG. 9 is a coil component according to another modification, corresponding to FIG. 5.

### DETAILED DESCRIPTION

The terms used herein is for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this code, specify the presence of stated features, integers, steps, operations, elements, components or a combination thereof, but do not preclude the presence or addition of one or more other features, integers, steps, operations, elements, components, and/or groups thereof. In addition, the terms “disposed on,” “positioned on,” and the like, may mean that an element is positioned on or below a target portion, and may not necessarily mean that the element is positioned on an upper side of the target portion with respect to a direction of gravity.

The terms “coupled to,” “connected to,” and the like, may not only indicate that elements are directly and physically in contact with each other, but also include a configuration in which another element is interposed between the elements such that the elements are also in contact with the other element.

The size and thickness of each element illustrated in the drawings is arbitrarily represented for ease of the description, but the present disclosure is not limited to those illustrated herein.

In the drawings, a Z-direction may be defined as a third direction or a length direction, a Y-direction may be defined as a second direction or a width direction, and an X-direction may be defined as a first direction or a thickness direction.

Hereinafter, a coil component according to an example embodiment of the present disclosure will be described in detail with reference to the accompanying drawings. In the description with reference to the accompanying drawings, the same or corresponding elements are denoted by the same reference numerals and repeated descriptions thereof will be omitted.

Various types of electronic components may be used in electronic devices, and various types of coil components may be appropriately used between such electronic components to remove noise.

That is, in an electronic device, a coil component may be used as a power inductor, a high frequency (HF) inductor, a general bead, a high-frequency bead (GHz bead), a common mode filter, or the like.

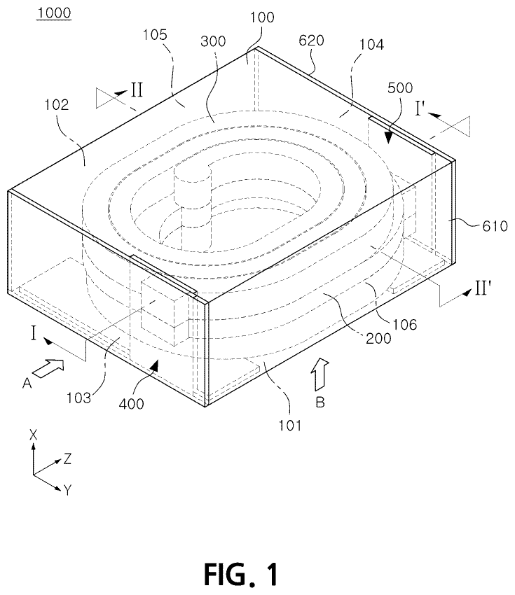

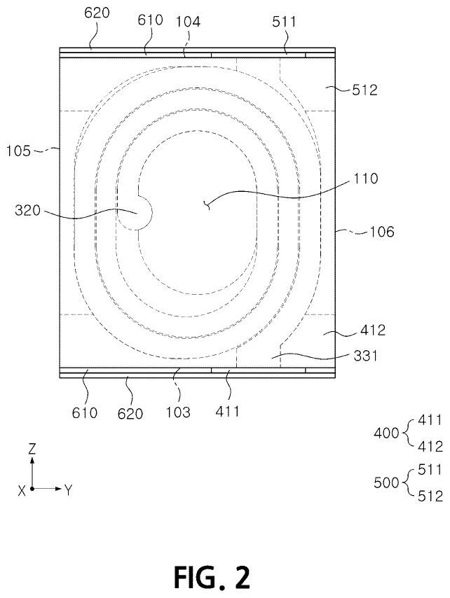

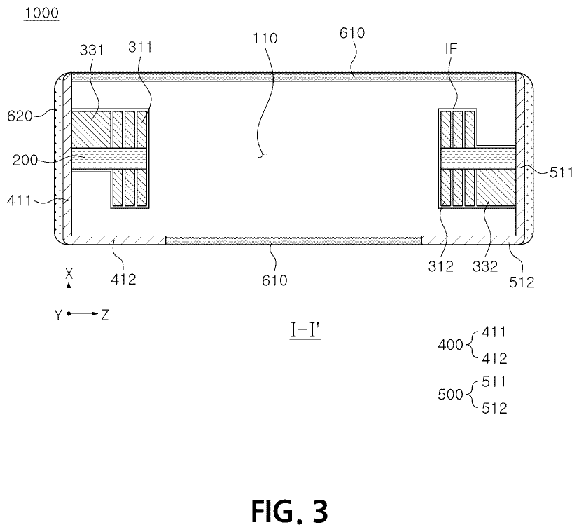

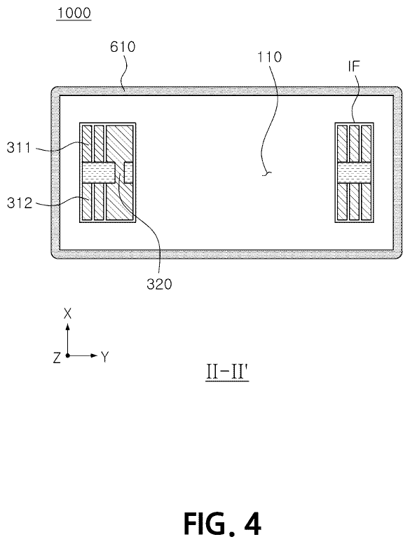

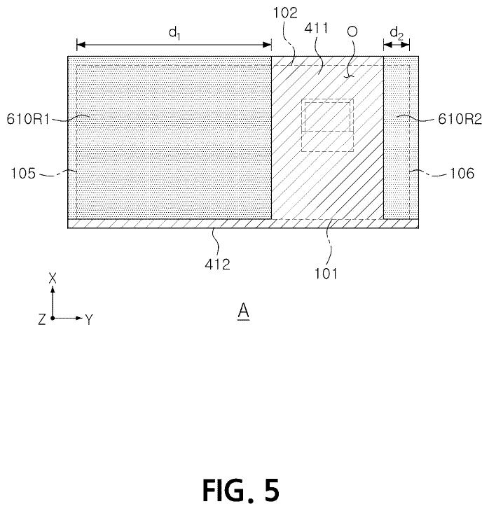

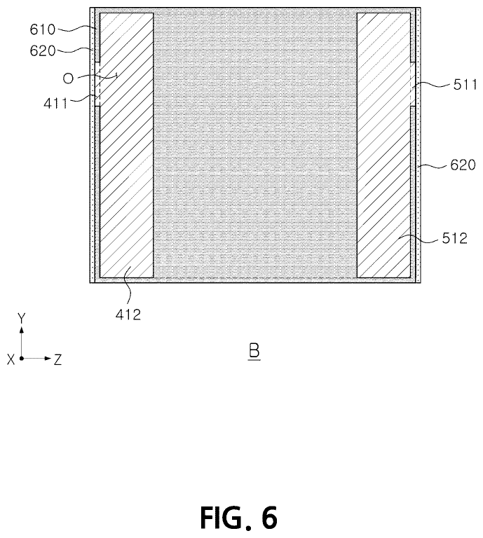

FIG. 1 is a schematic view of a coil component according to an example embodiment of the present disclosure. FIG. 2 is a top view of FIG. 1. FIG. 3 is a cross-sectional view taken along line I-I′ of FIG. 1. FIG. 4 is a cross-sectional view taken along line II-II′ of FIG. 1. FIG. 5 is a view of FIG. 1 in a direction of A. FIG. 6 is a view of FIG. 1 in a direction of B. In FIG. 5, for ease of understanding and description of the present example embodiment, a second insulating layer 620 is omitted.

Referring to FIGS. 1 to 6, a coil component 1000 according to an example embodiment of the present disclosure may include a body 100, a coil 300, external electrodes 400 and 500, and a first insulating layer 610, and may further include a support member 200, an insulating layer IF, and a second insulating layer 620.

The body 100 may form the overall exterior of the coil component 1000 according to the present example embodiment, and may include the coil 300 buried therein.

The body 100 may have an overall hexahedral shape.

Hereinafter, an example embodiment of the present disclosure will be described on the assumption that the body 100 has a hexahedral shape. However, the description does not exclude a coil component including a body having a shape other than a hexahedral shape from the scope of the present example embodiment.

The body 100 may have a first surface 101 and a second surface 102 opposing each other in an X-direction (first direction), a first side surface 105 and a second side surface 106 opposing each other in a Y-direction (second direction), and a third side surface 103 and a fourth side surface 104 opposing each other in a Z-direction (third direction). The first to fourth side surfaces 105, 106 ,103, and 104 of the body 100 may respectively correspond to a plurality of side surfaces of the body 100, connecting the first surface 101 and the second surface 102 of the body 100 to each other. When the coil component 1000 according to the present example embodiment is mounted on a mounting substrate such as a printed circuit board, the first surface 101 of the body 100 may be disposed to face a mounting surface of the mounting substrate, thereby allowing the coil component to be mounted on the mounting substrate.

The body 100 may be formed such that the coil component 1000 according to the present example embodiment, including the external electrodes 510 and 520 and insulating layers 610 and 620 to be described below, has a length of 2.0 mm, a width of 1.2 mm, and a thickness of 0.65 mm, but the present disclosure is not limited thereto. Tolerances are excluded from the above-described values of the length, width, and thickness of the coil component, and thus actual length, width, and thickness of the coil component may have values different from the above-described values due to tolerances.

The body 100 may include a magnetic material and a resin. Specifically, the body 100 may be formed by laminating one or more magnetic composite sheets in which the magnetic material is dispersed in the resin. However, the body 100 may have a structure other than a structure in which the magnetic material is dispersed in the resin. For example, the body 100 may be formed of a magnetic material such as ferrite, or may be formed of a non-magnetic material.

The magnetic material may be ferrite or metal magnetic powder.

The ferrite may include, for example, at least one selected from the group consisting of spinel-type ferrite such as Mg-Zn-based ferrite, Mn-Zn-based ferrite, Mn-Mg-based ferrite, Cu-Zn-based ferrite, Mg-Mn-Sr-based ferrite, Ni-Zn-based ferrite, or the like, hexagonal ferrite such as Ba-Zn-based ferrite, Ba-Mg-based ferrite, Ba-Ni-based ferrite, Ba-Co-based ferrite, Ba-Ni-Co-based ferrite, or the like, garnet-type ferrite such as Y-based ferrite or the like, and Li-based ferrite.

The magnetic metal powder may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder may include at least one selected from the group consisting of pure iron powder, Fe-Si-based alloy powder, Fe-Si-Al-based alloy powder, Fe-Ni-based alloy powder, Fe-Ni-Mo-based alloy powder, Fe-Ni-Mo-Cu-based alloy powder, Fe-Co-based alloy powder, Fe-Ni-Co-based alloy powder, Fe-Cr-based alloy powder, Fe-Cr-Si-based alloy powder, Fe-Si-Cu-Nb-based alloy powder, Fe-Ni-Cr-based alloy powder, and Fe-Cr-Al-based alloy powder.

The magnetic metal powder may be amorphous or crystalline. For example, the magnetic metal powder may be Fe-Si-B-Cr-based amorphous alloy powder, but the present disclosure is not necessarily limited thereto.

In the body 100, the ferrite and metal magnetic powder may be existed in a form of magnetic particle, and the ferrite particle and metal magnetic particle may respectively have an average diameter of about 0.1 μm to 30 μm, but an embodiment thereof is not limited thereto.

The body 100 may include two or more types of magnetic materials dispersed in the resin. Here, different types of magnetic materials mean that the magnetic materials dispersed in the resin are distinguished from each other in terms of one of an average diameter, a composition, crystallinity, and a shape.

The resin may include epoxy, polyimide, a liquid crystal polymer, or the like alone or in combination, but the present disclosure is not limited thereto.

The body 100 may include a core 110 passing through the coil 300 to be described below. The core 110 may be formed by filling a through-hole of the coil 300 with a magnetic composite sheet, but the present disclosure is not limited thereto.

The support member 200 may be buried in the body 100. The support member 200 may support the coil 300 to be described below.

The support member 200 may be formed of an insulating material including a thermosetting insulating resin such as an epoxy resin, a thermoplastic insulating resin such as polyimide, or a photosensitive insulating resin, or an insulating material in which a reinforcing material, such as a glass fiber or an inorganic filler, is impregnated with the above-described insulating resins. For example, the support member 200 may be formed of an insulating material such as a copper clad laminate (CCL), a prepreg, an Ajinomoto build-up film (ABF), FR-4, a bismaleimide triazine (BT) resin, a photoimageable dielectric (PID), or the like, but the present disclosure is not limited thereto.

The inorganic filler may include at least one selected from the group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

When the support member 200 is formed of an insulating material including a reinforcing material, the support member 200 may provide more excellent rigidity. When the support member 200 is formed of an insulating material, not including glass fiber, the support member 200 may be advantageous for a reduction in an overall thickness of the coil 300. When the support member 200 is formed of an insulating material including a photosensitive insulating resin, the number of processes may be reduced. Thus, it may be advantageous in reducing production costs, and a fine hole may be processed.

The coil 300 may be disposed in the body 100 to exhibit properties of the coil component 1000. For example, when the coil component 1000 according to the present example embodiment is used as a power inductor, the coil 300 may serve to stabilize power of an electronic device by storing an electric field as a magnetic field and maintaining an output voltage.

The coil 300 may be disposed on one surface of the support member 200 to form at least one turn. In the present example embodiment, the coil 300 may include a first coil pattern 311 and a first lead-out portion 331 disposed on one surface of the support member 200 opposing the second surface 102 of the body 100, a second coil pattern 312 and a second lead-out portion 332 disposed on the other surface of the support member 200, and a via 320 passing through the support member 200, the via 320 connecting the first coil pattern 311 and the second coil pattern 312 to each other. As a result, the coil 300 according to the present example embodiment may be formed as a single coil generating a magnetic field in a first direction (X-direction) of the body 100 with respect to the core 110.

Each of the first coil pattern 311 and the second coil pattern 312 may be in the form of a planar spiral shape having at least one turn around the core 110 of the body 100. For example, with respect to the directions of FIGS. 1, 3, and 4, the first coil pattern 311 may form at least one turn around the core 110 on an upper surface of the support member 200. The second coil pattern 312 may form at least one turn around the core 110 on a lower surface of the support member 200.

The lead-out portions 331 and 332 may be connected to the coil patterns 311 and 312, respectively, and may extend to the third side surface 103 and the fourth side surface 104 of the body 100. Specifically, the first lead-out portion 331 may be disposed on one surface (upper surface) of the support member 200, may be connected to the first coil pattern 311, and may extend to the third side surface 103 of the body 100. The second lead-out portion 332 may be disposed on the other surface (lower surface) of the support member 200, may be connected to the second coil pattern 312, and may extend to the fourth side surface 104 of the body 100. The lead-out portions 331 and 332 may extend to the third side surface and the fourth side surface 103 and 104 of the body 100, and may be in contact with and connected to external electrodes 400 and 500 to be described below.

A distance between the lead-out portions 331 and 332 and the first side surface 105 may differ from a distance between the lead-out portions 331 and 332 and the second side surface 106. Referring to FIG. 2, the lead-out portions 331 and 332 may be disposed to be closer to the second side surface 106 than to the first side surface 105. However, the present disclosure is not limited thereto, and the lead-out portions 331 and 332 may also be disposed to be closer to the first side surface 105 than to the second side surface 106. The lead-out portions 331 and 332 may be disposed to be closer to the first side surface 105 or the second side surface 106 as described above, thereby securing a size of an air core.

At least one of the coil patterns 311 and 312, the via 320, or the lead-out portions 331 and 332 may include at least one conductive layer.

For example, when the first coil pattern 311, the via 320, and the first lead-out portion 331 are formed by plating, each of the first coil pattern 311, the via 320, and the first lead-out portion 331 may include a seed layer formed by vapor deposition such as electroless plating or sputtering, and an electroplating layer. Here, the electroplating layer may have a single-layer structure or a multilayer structure. The electroplating layer having a multilayer structure may be formed in a conformal film structure in which one electroplating layer covers another electroplating layer, or may be formed in a shape in which one electroplating layer is laminated only on one surface of another electroplating layer. Seed layers of the first coil pattern 311, the via 320, and the first lead-out portion 331 may be integrally formed, such that boundaries therebetween may not be formed, but the present disclosure is not limited thereto. Electroplating layers of the first coil pattern 311, the via 320, and the first lead-out portion 331 may also be integrally formed, such that boundaries therebetween may not be formed, but the present disclosure is not limited thereto.

As another example, when the first coil pattern 311 and the second coil pattern 312 are separately formed and then collectively laminated on the support member 200 to form the coil 300, the via 320 may include a high-melting-point metal layer and a low-melting-point metal layer having a melting point lower than that of the high-melting-point metal layer. Here, the low-melting-point metal layer may be formed of solder including lead (Pb) and/or tin (Sn). At least a portion of the low-melting-point metal layer may melt due to pressure and temperature during collective lamination, and an intermetallic compound (IMC) layer may be formed at a boundary between the low-melting-point metal layer and the first coil pattern 311.

The first coil pattern 311 and the second coil pattern 312 may, for example, be protrudingly formed on upper and lower surfaces of the support member 200, respectively. As another example, the first coil pattern 311 may be buried in the upper surface of the support member 200, such that an upper surface of the first coil pattern 311 may be exposed to the upper surface of the support member 200, and the second coil pattern 312 may be protrudingly formed on the lower surface of the support member 200. In this case, a recessed portion may be formed on the upper surface of the first coil pattern 311, and the upper surface of the support member 200 and the upper surface of the first coil pattern 311 may not be coplanar with each other. As another example, the first coil pattern 311 may be buried in the upper surface of the support member 200, such that the upper surface of the first coil pattern 311 may be exposed to the upper surface of the support member 200, and the second coil pattern 312 may be buried in the lower surface of the support member 200, such that a lower surface of the second coil pattern 312 may be exposed to the lower surface of the support member 200.

Each of the coil patterns 311 and 312, the via 320, and the lead-out portions 331 and 332 may include a conductive material such as copper (Cu), aluminum (Al), silver (Ag), tin (Sn), gold (Au), nickel (Ni), lead (Pb), titanium (Ti), molybdenum (Mo), or an alloy thereof, but the present disclosure is not limited thereto.

The external electrodes 400 and 500 may be disposed on the third side surface 103 and the fourth side surface 104 of the body 100, and may extend to the first surface 101 of the body 100. The external electrodes 400 and 500 may be connected to the lead-out portions 331 and 332, and accordingly may serve to electrically connect the coil 300 in the coil component 1000 to an electronic device when the coil component 1000 is mounted on the electronic device.

The external electrodes 400 and 500 may include a first external electrode 400 disposed on the third side surface 103 of the body 100, the first external electrode 400 connected to the first lead-out portion 331, and a second external electrode 500 disposed on the fourth side surface 104 of the body 100, the second external electrode 500 connected to the second lead-out portion 332. The first and second external electrodes 400 and 500 may be spaced apart from each other in a third direction (Z-direction), such that the first and second external electrodes 400 and 500 may not be in contact with each other on the first surface 101 of the body 100. Hereinafter, the first external electrode 400 will be described as a representative example, and the description of the second external electrode 500 may be repeated, and thus will be omitted.

The first external electrode 400 may include a first connection portion 411 disposed on the third side surface 103 of the body 100, and a first extension portion 412 extending from the first connection portion 411 to the first surface 101 of the body 100.

The first connection portion 411 may be disposed on the third side surface 103 of the body 100, and may be in contact with and connected to the first lead-out portion 331. At least a portion of the first connection portion 411 may be disposed in an opening O of the first insulating layer 610 to be described later, and a side surface of the connection portion 411 may be in contact with the first insulating layer 610.

A distance d1 between one side of the first connection portion 411 closer to the first side surface and the first side surface 105 may be different from a distance d2 between the other side of the first connection portion 411 closer to the second side surface 106 and the second side surface 106. Referring to FIG. 5, the distance d1 may be greater than the distance d2. A difference between values of d1 and d2 may mean, for example, that d1 and d2 have a length difference of 100 μm or more. However, the present disclosure is not limited thereto, and the difference between the values of d1 and d2 may include cases in which a meaningful length difference exists depending on a size of the coil component 1000.

In addition, the connection portions 411 and 511 may be disposed on only one side of a middle surface M positioned between the first side surface 105 and the second side surface 106 of the body 100. A distance between the first connection portion 411 and the first side surface 105 may be measured by the following method. The first insulating layer 610 may be removed from the coil component 1000 to obtain a length of a line segment, parallel to a second direction (Y-direction), connecting the first side surface 105 and the first connection portion 411 to each other. In this case, five arbitrary points, spaced apart from each other in a first direction (X-direction), may be selected, and lengths of a plurality of line segments at the five points may be obtained. The distance between the first connection portion 411 and the first side surface 105 may refer to an arithmetic average value of the lengths of the plurality of line segments. Similarly, a distance between the first connection portion 411 and the second side surface 106 may be measured by analogy to the above description.

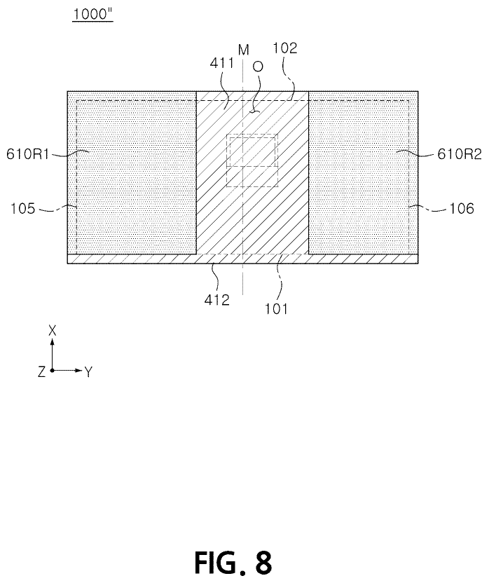

As described above, the first connection portion 411 may be disposed to be closer to the second side surface 106 than to the first side surface 105 of the body 100. However, the present disclosure is not limited thereto, and the first connection portion 411 may be disposed to be closer to the first side surface 105 than to the second side surface 106 of the body 100. In addition, as illustrated in FIG. 8, the connection portions 411 and 511 may be disposed to straddle the middle surface M.

To reduce parasitic capacitance between the coil 300 and the external electrodes 400 and 500, a distance between the coil 300 and the external electrodes 400 and 500 may be adjusted. In a coil component according to the related art, an outermost turn of the coil 300 and the external electrodes 400 and 500 may be on the same line in a third direction (Z-direction). Thus, to adjust the distance between the coil 300 and the external electrodes 400 and 500, a margin of the coil 300 in the third direction (Z-direction) may be inevitably adjusted. In this case, although SRF properties may be improved, a size of an air core may be reduced, resulting in a decrease in Isat and an increase in Rdc.

Conversely, in the coil component according to the present example embodiment, the connection portion 411 may be disposed to be offset from the center of the third side surface 103 of the body 100. Thus, the distance between the coil 300 and the external electrodes 400 and 500 may be adjusted without changing the margin of the coil 300. Referring to FIG. 2, an outermost point of the coil 300 in the third direction (Z-direction) may not be on the same line as the connection portion 411. That is, an outermost turn of the coil 300 and the connection portions 411 and 511 may not be on the same line in the third direction (Z-direction), and may be obliquely disposed in the second direction (Y-direction). Accordingly, a size of an air core of the coil 300 may be secured while a distance between the coil 300 and the connection portion 411 is sufficiently secured, thereby improving self-resonance frequency (SRF) properties.

Referring to FIG. 2, the second connection portion 511 may be disposed on the fourth side surface 104 of the body 100 to be closer to the second side surface 106 than to the first side surface 105. That is, the second connection portion 511 may also be disposed to be misaligned in a direction the same as that of the first connection portion 411. Accordingly, when viewed in the third direction, the first connection portion 411 and the second connection portion 511 may at least partially overlap each other.

The first extension portion 412 may be connected to the first connection portion 411 and disposed on the first surface 101 of the body 100. The first extension portion 412 and the second extension portion 512 may be disposed on the first surface 101 of the body 100 to be spaced apart from each other in the third direction (Z-direction). At least a portion of the first extension portion 412 may be disposed in an opening O of the first insulating layer 610 to be described below, and a side surface of the first extension portion 412 may be in contact with the first insulating layer 610.

The external electrodes 400 and 500 may be formed on a surface of the body 100 by performing electroplating using the first insulating layer 610 formed on the surface of the body 100 as a plating resist. When the body 100 includes magnetic particles, the magnetic particles may be exposed to the surface of the body 100. Due to the magnetic particles exposed to the surface of the body 100, conductivity may be imparted to the surface of the body 100 during electroplating, and the external electrodes 400 and 500 may be formed on the surface of the body 100 by electroplating.

The connection portions 411 and 511 and the extension portions 412 and 512 of the external electrodes 400 and 500 may be formed by the same plating process, such that boundaries therebetween may not be formed. That is, the first connection portion 411 and the first extension portion 412 may be integrally formed, and the second connection portion 511 and the second extension portion 512 may be integrally formed. In addition, the connection portions 411 and 511 and the extension portions 412 and 512 may be formed of the same metal. However, the description does not exclude a case in which the connection portions 411 and 511 and the extension portions 412 and 512 are formed by different plating processes, such that boundaries therebetween are formed from the scope of the present disclosure.

The external electrodes 400 and 500 may include a conductive material such as at least one selected from the group consisting of copper (Cu), aluminum (Al), silver (Ag), tin (Sn), gold (Au), nickel (Ni), lead (Pb), titanium (Ti), and alloys thereof, but the present disclosure is not limited thereto.

The external electrodes 400 and 500 may be formed to have a thickness in the range of 0.5 μm to 100 μm. When the thickness of the external electrodes 400 and 500 is less than 0.5 μm, detachment or delamination may occur when mounted on a substrate. When the thickness is greater 100 μm, it may be disadvantageous for reducing a thickness

### Of the Coil Component.

The first insulating layer 610 may be disposed on the third side surface 103 and the fourth side surface 104 of the body 100 to expose the connection portions 411 and 511. In addition, the first insulating layer 610 may be disposed on the first surface, the second surface, and the first to fourth side surfaces of the body 100. The first insulating layer 610 may be formed to surround the entire surface of the body 100, together with the external electrodes 400 and 500. The first insulating layer 610 may function as a plating resist in forming the external electrodes 400 and 500 by electroplating, but the present disclosure is not limited thereto.

An opening O, in which the external electrodes 400 and 500 are to be disposed, may be formed in the first insulating layer 610. The opening O of the first insulating layer 610 may be formed on the third side surface 103, the fourth side surface 104, and the first surface 101 of the body 100. The opening O may extend from the third side surface 103 to the first surface 101, or from the fourth side surface 104 to the first surface 101. Referring to FIGS. 5 and 6, at least a portion of the connection portions 411 and 511 and the extension portions 412 and 512 may be disposed in the opening O.

Thus, the first insulating layer 610 may expose the connection portions 411 and 511 and the extension portions 412 and 512.

The first insulating layer 610 may include a thermoplastic resin such as a polystyrene-based resin, a vinyl acetate-based resin, a polyester-based resin, a polyethylene-based resin, a polypropylene-based resin, a polyamide-based resin, a rubber-based resin, an acryl-based resin, or the like, a thermosetting resin such as a phenol-based resin, an epoxy-based resin, a urethane-based resin, a melamine-based resin, an alkyd-based resin, or the like, a photosensitive resin, parylene, SiOₓ (0<x<1)or SiNₓ (0<x<1).

The first insulating layer 610 may have an adhesive function. For example, when the first insulating layer 610 is formed by laminating an insulating film on the body 100, the insulating film may include an adhesive element, and thus may be attached to the surface of the body 100. In this case, an adhesive layer may be formed on one surface of the first insulating layer 610. However, in some cases, such as when a semi-cured (B-stage) insulating film is used to form the first insulating layer 610, an adhesive layer may not be formed on one surface of the first insulating layer 610.

The first insulating layer 610 may be formed by coating a liquid insulating resin on the surface of the body 100, laminating an insulating film on the surface of the body 100, or forming an insulating resin on the surface of the body 100 by vapor deposition. Examples of the insulating film may include a dry film (DF) including a photosensitive insulating resin, an Ajinomoto Build-up Film (ABF) not including a photosensitive insulating resin, or a polyimide film.

The first insulating layer 610 may be formed to have a thickness in the range of 10 nm to 100 μm. When the thickness of the first insulating layer 610 is less than 10 nm, the coil component may have reduced properties, such as a reduction in Q factor, a reduction in breakdown voltage, and a reduction in self-resonant frequency (SRF). When the thickness of the first insulating layer 610 is greater than 100 μm, an overall length, width, and thickness of the coil component may increase, which may be disadvantageous for a reduction in thickness.

Hereinafter, an arrangement relationship between the first insulating layer 610 and the first external electrode 400 will be described with respect to the third side surface 103 of the body 100. However, the description may be equally applied to the first insulating layer 610 and the second external electrode 500 disposed on the fourth side surface 104 of the body 100.

Referring to FIG. 5, the first insulating layer 610 may be disposed on the third side surface 103 of a body 100, and may have one region 610R1 and the other region 610R2, spaced apart from each other in the second direction (Y-direction). For example, after the first insulating layer 610 is formed on the entire third side surface 103 of the body 100, an opening O that is in the form of a slit extending in the first direction (X-direction) may be formed in the first insulating layer 610 to expose a portion of the third side surface 103 of the body 100, and thus the one region 610R1 and the other region 610R2 of the first insulating layer 610 may be spaced apart from each other. The opening O may be formed in the first insulating layer 610 by a physical and/or chemical processing method, and may expose the third side surface 103 of the body 100. The first connection portion 411 of the first external electrode 400 may be formed on the third side surface 103 of the body 100 exposed through the opening O. The first connection portion 411 may be disposed between the one region 610R1 and the other region 610R2 of the first insulating layer 610, and may be in contact with and connected to the first lead-out portion 331.

A length of the one region 610R1 in the second direction (Y-direction) may be different from a length of the other region 610R2 in the second direction (Y-direction). As described above, the first connection portion 411 may be disposed to be closer to the first side surface 105 than to the second side surface 106 of the body 100, and thus the length of the one region 610R1 in the second direction (Y-direction) may be greater than the length of the other region 610R2 in the second direction. However, the present disclosure is not limited thereto, and the length of the other region 610R2 in the second direction may also be greater than the length of the one region 610R1 in the second direction (Y-direction).

The length of the one region 610R1 in the second direction (Y-direction) may be measured by the following method. A length of a line segment parallel to the second direction (Y-direction), the line segment connecting two outermost boundary lines of the one region 610R1 opposing each other in the second direction (Y-direction), may be obtained. In this case, five arbitrary points, spaced apart from each other in the first direction (X-direction), may be selected, and lengths of a plurality of line segments at the five points may be obtained. The length of the one region 610R1 in the second direction (Y-direction) may refer to an arithmetic average value of the lengths of the plurality of line segments. Similarly, the length of the other region 610R2 in the second direction (Y-direction) may be measured by analogy to the above description.

The second insulating layer 620 may be disposed on each of the third side surface and the fourth side surface 103 and 104 of the body 100, and may cover the first insulating layer 610 and the connection portions 411 and 511 disposed on the third side surface and the fourth side surface 103 and 104 of the body. The second insulating layer 620 may cover the connection portions 411 and 511 of the first and second external electrodes 400 and 500, thereby preventing the coil component 1000 according to the present example embodiment from being short-circuited with other electronic components that are mounted to be adjacent thereto when mounted on a mounting substrate such as a printed circuit board.

The second insulating layer 620 may include a thermoplastic resin such as a polystyrene-based resin, a vinyl acetate-based resin, a polyester-based resin, a polyethylene-based resin, a polypropylene-based resin, a polyamide-based resin, a rubber-based resin, an acryl-based resin, or the like, a thermosetting resin such as a phenol-based resin, an epoxy-based resin, a urethane-based resin, a melamine-based resin, an alkyd-based resin, or the like, a photosensitive resin, parylene, SiOₓ or SiNₓ.

The second insulating layer 620 may have an adhesive function. For example, when the second insulating layer 620 is formed by laminating an insulating film on the body 100, the insulating film may include an adhesive element. In this case, an adhesive layer may be formed on one surface of the second insulating layer 620. However, in some cases, such as when a semi-cured (B-stage) insulating film is used to form the second insulating layer 620, an adhesive layer may not be formed on one surface of the second insulating layer 620.

The second insulating layer 620 may be formed by coating a liquid insulating resin on the surface of the body 100, laminating an insulating film on the surface of the body 100, or forming an insulating resin on the surface of the body 100 by vapor deposition. Examples of the insulating film may include a DF including a photosensitive insulating resin, an ABF not including a photosensitive insulating resin, or a polyimide film.

The second insulating layer 620 may be formed to have a thickness in the range of 10 nm to 100 μm. When the thickness of the second insulating layer 620 is less than 10 nm, the coil component may have reduced properties, such as a reduction in Q factor, a reduction in breakdown voltage, and a reduction in SRF. When the thickness of the second insulating layer 620 is greater than 100 μm, an overall length, width, and thickness of the coil component may increase, which may be disadvantageous for a reduction in thickness.

An insulating film IF may be disposed along a surface of the coil 300.

The insulating film IF may insulate between the coil 300 and the body 100. The insulating film IF may cover an external surface of the coil 300, thereby insulating the coil 300 from the body 100. The insulating film IF may be disposed between adjacent turns of the coil, and may also be disposed on the support member 200.

The insulating film IF may include a known insulating material such as parylene or the like, but the present disclosure is not limited thereto. As another example, the insulating film IF may include an insulating material such as an epoxy resin or the like, rather than parylene. The insulating film IF may be formed by vapor deposition, but the present disclosure is not limited thereto. As another example, the insulating film IF may be formed by laminating and curing an insulating film for forming the insulating film IF on both surfaces of the support member 200 on which the coil 300 is formed. Alternatively, the insulating film IF may be formed by coating and curing an insulating paste for forming the insulating film IF on both surfaces of the support member 200 on which the coil 300 is formed.

In the present disclosure, the insulating film IF may be an optional element. When the body 100 is capable of securing sufficient electrical resistance under an operating condition of the coil component 1000 according to the present example embodiment, the insulating film IF may be omitted.

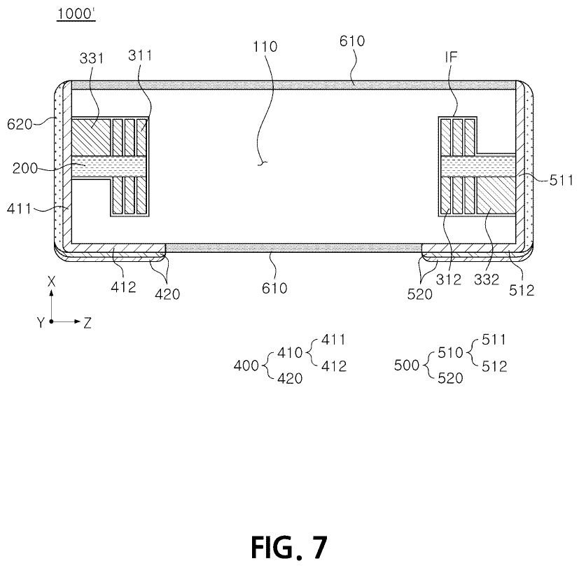

FIG. 7 is a coil component according to a modification, corresponding to FIG. 3.

Referring to FIG. 7, a coil component 1000′ according to the present example embodiment may differ from the coil component 1000 according to an example embodiment of the present disclosure in terms of external electrodes 400 and 500.

The external electrodes 400 and 500 may further include metal layers 420 and 520 disposed on extension portions 412 and 512. Specifically, a first external electrode 400 may include a first electrode layer 410 including a first connection portion 411 and a first extension portion 412, and a first metal layer 420 disposed on the first extension portion 412. The second external electrode 500 may include a second electrode layer 510 including a second connection portion 511 and a second extension portion 512, and a second metal layer 520 disposed on the second extension portion 512. The metal layers 420 and 520 may include nickel Ni or tin Sn. As illustrated in FIG. 7, each of the metal layers 420 and 520 may be formed as a plurality of layers. In this case, each of the metal layers 420 and 520 may have a double-layer structure including a nickel Ni plating layer disposed on each of the extension portions 412 and 512 and a tin Sn plating layer disposed on the nickel Ni plating layer, but the present disclosure is not limited thereto.

FIG. 8 is a coil component according to another modification, corresponding to FIG. 5.

Referring to FIG. 8, a coil component 1000″ according to the present example embodiment may differ from the coil component 1000 according to an example embodiment of the present disclosure in terms of an arrangement of connection portions 411 and 511.

The connection portions 411 and 511 may be disposed to straddle a middle surface M positioned between a first side surface 105 and a second side surface 106 of a body 100. Referring to FIG. 8, at least a portion of the connection portions 411 and 511 may be disposed on both sides of the middle surface M.

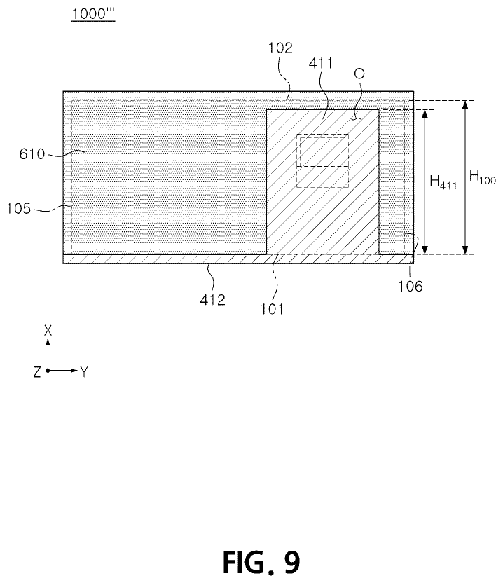

FIG. 9 is a coil component according to another modification, corresponding to FIG. 5.

Referring to FIG. 9, a coil component 1000″′ according to the present example embodiment may differ from the coil component 1000 according to an example embodiment of the present disclosure in terms of a shape of a first insulating layer 610 and a height of connection portions 411 and 511.

An opening O of the first insulating layer 610 may not extend to a second surface 102 of a body 100. Accordingly, the first insulating layer 610 may not have one region and the other region, spaced apart from each other in a second direction (Y-direction).

A height H411 of a first connection portion 411 may be less than a distance H100 between a first surface 101 and a second surface 102 of the body 100. That is, the height of the first connection portion 411 may be less than a height of the body 100. By reducing the height of the first connection portion 411, an area of an external electrode, forming parasitic capacitance, may be reduced, and SRF properties may be improved.

While example embodiments have been shown and described above, it will be apparent to those skilled in the art that modifications and variations could be made without departing from the scope of the present disclosure as defined by the appended claims.

What is claimed is:

1. A coil component comprising:
a body having a first surface and a second surface, opposing each other in a first direction, a first side surface and a second side surface, opposing each other in a second direction, and a third side surface connecting the first side surface and the second side surface to each other;
a coil disposed in the body, the coil including a lead-out portion extending to the third side surface of the body;
an external electrode disposed on the third side surface of the body, the external electrode including a connection portion connected to the lead-out portion; and
a first insulating layer disposed on the third side surface of the body on which the connection potion is not disposed such that the first insulating layer exposing the connection portion,
wherein a distance between the connection portion of the external electrode and the first side surface of the body is different from a distance between the connection portion of the external electrode and the second side surface of the body.

2. The coil component of claim 1, wherein
the first insulating layer has an opening in which at least a portion of the connection portion is disposed, and
a side surface of the connection portion is in contact with the first insulating layer.

3. The coil component of claim 1, wherein the external electrode further includes an extension portion connected to the connection portion, the extension portion disposed on the first surface of the body.

4. The coil component of claim 1, wherein a length of the connection portion in the first direction is less than a distance between the first surface and the second surface of the body.

5. The coil component of claim 1, wherein the connection portion is disposed on only one side relative to a middle surface positioned between the first side surface and the second side surface.

6. The coil component of claim 1, wherein the body further has a fourth side surface opposing the third side surface of the body in a third direction.

7. The coil component of claim 6, wherein
the external electrode includes a first external electrode disposed on the third side surface of the body, and a second external electrode disposed on the fourth side surface of the body, and
a connection portion of the first external electrode and a connection portion of the second external electrode at least partially overlap each other, when viewed in the third direction.

8. The coil component of claim 6, wherein the lead-out portion includes a first lead-out portion extending to the third side surface of the body, and a second lead-out portion extending to the fourth side surface of the body.

9. The coil component of claim 1, further comprising:
a second insulating layer covering the first insulating layer and the connection portion.

10. The coil component of claim 3, wherein
the external electrode further includes a metal layer disposed on the extension portion, and
the metal layer includes nickel (Ni) or tin (Sn).

11. A coil component comprising:
a body having a first surface and a second surface, opposing each other in a first direction, a first side surface and a second side surface, connecting the first surface and the second surface to each other, the first side surface and the second side surface opposing each other in a second direction, and a third side surface connecting the first side surface and the second side surface to each other;
a coil disposed in the body, the coil including a lead-out portion extending to the third side surface of the body;
a first insulating layer disposed on the third side surface of the body, the first insulating layer having one region and other region spaced apart from each other in the second direction; and
an external electrode disposed between the one region and the other region of the first insulating layer on the third side surface of the body, the external electrode including a connection portion connected to the lead-out portion,
wherein a length of the one region in the second direction is different from a length of the other region in the second direction.

12. The coil of claim 11, wherein the first insulating layer exposes the connection portion.

13. The coil of claim 11, further comprising:
a second insulating layer covering the connection portion, and the one region and the other region of the first insulating layer.

14. The coil of claim 11, wherein the external electrode further includes an extension portion connected to the connection portion, the extension portion disposed on the first surface of the body.
